(19) United States
(12) Patent Application Publication
(10) Pub. No.: US 2004/0163419 A1
(43) Pub. Date: Aug. 26, 2004

(54) Method and apparatus for forming low optical loss splices

(76) Inventors: Eric Mics, Matawan, NJ (US); Latha Venkataraman, New York City, NY (US)

Correspondence Address: GLEN E. BOOKS, ESQ., LOWENSTEIN SANDLER PC, 65 LIVINGSTON AVENUE, ROSELAND, NJ, 07068, US

(21) Appl. No.: 10/717,856

(22) Filed: Nov. 19, 2003

Related U.S. Application Data
(60) Provisional application No. 60/427,893, filed on Nov. 20, 2002.

(51) Int. Cl. C03B 37/15

(52) U.S. Cl. 65/407

(57) ABSTRACT

The invention is directed to methods for adiabatically expanding the mode-field diameter of an optical fiber by heating the end of the optical fiber. The fiber's end is heated by a heat source, preferably, a flame fueled by an organic liquid. Preferably, the organic-liquid fuel is an alcohol, more preferably, an alcohol having six or fewer carbon atoms and only one hydroxyl group, and optimally methanol.

This application claims the benefit of U.S. Provisional Application No. 60/427,893 filed Nov. 20, 2002, entitled Method and Apparatus for Forming Low-Loss Splices Between Transmission Optical Fibers and Specialty Optical Fibers, by E. Mies et al., which application is hereby incorporated herein by reference.

### 1. FIELD

This invention relates to methods of splicing optical fibers with low optical loss and, in particular, to methods for splicing transmission fibers to specialty fibers.

### 2. BACKGROUND

Optical fibers are key components in modern telecommunication systems. An optical fiber is a thin strand of glass, capable of transmitting optical signals over long distances with very low loss. In its simplest form, an optical fiber is a cylindrical wave guide comprising a small-diameter silica core having a first index of refraction surrounded by a silica cladding having a second (lower) index of refraction. A polymeric coating surrounding the cladding protects the fiber. Typically, optical fibers are constructed of high-purity silica glass having minor concentrations of dopants to control the index of refraction.

The class of optical fibers includes transmission fibers and a variety of specialty fibers. Standard transmission fibers simply transmit optical-signal pulses over long distances. Specialty fibers, such as dispersion compensating fibers (DCF fibers), erbium-doped fibers, fibers containing Bragg gratings, and long-period grating fibers perform specialized, ancillary functions. Dispersion compensating fibers compensate chromatic dispersion occurring during transmission. Rare-earth doped fibers amplify optical pulses, which is particularly necessary after passage through long lengths of transmission fiber. Each different type of fiber is formed with different geometries or different dopant distributions to perform its intended function.

In the formation and reconfiguration of fiber networks, it is often necessary to splice different kinds of optical fibers together. The splice should exhibit low connection losses, or “splice losses”. The closer the mode-field diameters and the mode-field shapes of the fibers match, the lower the splice loss. The mode-field diameters can be matched before or after splicing. A mode is a stable propagation state in an optical fiber. Mode-field diameter refers to the effective size of the mode. In most optical fibers, the mode-field diameter is slightly larger than the core diameter. Unfortunately, however, specialty fibers and the fibers or devices to which they will be spliced, usually have significantly mismatched mode-field diameters resulting in unacceptable splice loss.

A common method of matching the mode-field diameters of optical fibers is heat-induced diffusion. Heat-induced diffusion is generally used in conjunction with fusion splicing (i.e., melting the ends of the optical fibers together). Fusion splicing typically involves mechanical alignment of two fiber ends and melting them together under high heat, for example, by way of an arc welder, for about 1-10 seconds. The optical fibers are first fusion spliced at high temperatures using an arc welder. Then heat-induced diffusion to match the mode fields is accomplished after splicing by heating the spliced region. See e.g., the discussion in U.S. Pat. No. 6,275,627 (issued Aug. 14, 2001); H. Y. Tam, Simple Fusion Splicing Technique For Reducing Splicing Loss Between Standard Single Mode Fibres And Erbium-Doped Fibre, 27 ELECTRONIC LETTERS 1597 (1991).

Unfortunately, because dispersion compensating fibers have complex index profiles and wave-guiding properties, heat-induced diffusion is difficult and often results in mode-field distortions and kinking.

Accordingly, there is a need for convenient, effective methods to adiabatically expand dispersion compensating fibers to match the mode-field to larger-core optical fibers so that the fibers can be spliced with low optical loss.

### 3. SUMMARY

In one embodiment, the invention is directed to methods for adiabatically expanding the mode-field diameter of an optical fiber by heating the end of the optical fiber, particularly the end of a dispersion compensating fiber. The methods of the invention improve over prior-art methods that comprise first heating an internal section of an optical fiber and then cleaving the fiber at the heat-treated portion.

In one embodiment of the invention, the fiber's end is heated by a heat source, preferably, a flame fueled by an organic liquid. Preferably, the organic-liquid fuel is an alcohol, more preferably, an alcohol having six or fewer carbon atoms and only one hydroxyl group, and optimally methanol. In a preferred aspect of the invention, the organic fuel is fed by way of a wick, which when lit, provides the flame.

In another embodiment, the invention is useful in splicing of optical fibers having mismatched mode fields with low optical loss. In this embodiment, the mode field of smaller mode-field diameter fiber is adiabatically expanded to match that of a larger mode-field diameter fiber by first heating an end of the smaller mode-field fiber. Once the mode-field diameters are matched, the expanded mode-field fiber and large mode-field fiber are spliced by standard splicing methods, for example, by heat induced fusion or mechanical connection methods.

Preferably, the end of the smaller mode-field diameter optical fiber is heated in a flame fueled by an organic liquid. In a preferred embodiment, the organic liquid comprises an alcohol, more preferably, an alcohol having six or fewer carbon atoms and only one hydroxyl group, and optimally methanol. Advantageously, splice losses of under 0.5 dB are achieved, typically, from about 0.05 dB to about 0.3 dB, preferably, from about 0.05 dB to about 0.2 dB, more preferably, from about 0.05 to about 0.1 dB.

It has been found that organic liquids, particularly alcohols, more particularly, alcohols having six or fewer carbon atoms and only one hydroxyl group, and optimally, methanol, provide flames having an ideal temperature profile for adiabatic mode-field expansion of specialty fibers, particularly, for adiabatic expansion of dispersion compensating fibers. Such flames provide a lower temperature profile than typical oxygen/hydrogen or oxygen/hydrocarbon-gas fueled flames and thus provide a more gradual, adiabatic expansion than can be obtained with other heat sources. Furthermore, since a liquid fuel is used, the inconvenience of handling and mixing gases is avoided.

According to the methods of the invention, because the end of the optical fiber to be spliced is heated, rather than an internal section, issues related to exact alignment of the fiber; maintaining a precise tension of the fiber; and issues of mode-field distortions are precluded. Furthermore, the methods of the invention do not require expensive equipment, are convenient, and give low splice losses.

### 4. BRIEF DESCRIPTION OF THE FIGURES

These and other features, aspects, and advantages of the present invention will become better understood with regard to the following description, appended claims, and accompanying drawings where:

FIGS. 1-3 are illustrations of an apparatus suitable for carrying out the methods of the invention.

It is to be understood that these drawings are for purposes of illustrating the concepts of the invention and are not to scale.

### 5. DETAILED DESCRIPTION

According to one embodiment of the invention, optical fibers of differing mode-field diameters are connected in a splice of low optical loss as follows. First, the optical fiber having the smaller mode-field diameter is stripped and cleaved according to well-known methods. The next step is to expose the cleaved end to a heat source for about 1 minute to about 40 minutes, more preferably, from about 10 minutes to about 30 minutes. Preferably, the heat source provides a temperature profile of from about 500° C. to about 2000° C. at the region where the optical fiber end is positioned, more preferably, of from about 1000° C. to about 1500° C., still more preferably, of from about 1100° C. to about 1200° C., and optimally about 1150° C.

The heat source can be any heat source, for example, an electric furnace or a flame produced by burning an organic solid or liquid, such as an alcohol. In one embodiment of the invention, the heat source is a flame fueled by an organic liquid. Preferably, a wick that is inserted into the organic liquid provides the flame. Preferably, the flame is fueled by an alcohol, more preferably, an alcohol having six or fewer carbon atoms and only one hydroxyl group, and optimally, methanol. The effect of the organic-liquid-fueled flame is to diffuse dopants within the fiber core and thereby match the mode-field diameter to that of the larger mode field fiber. An organic-liquid-fueled flame provides a near ideal temperature profile for diffusing the dopants in a dispersion compensating fiber. It causes the dopants to diffuse gradually along the length of fiber in the flame, resulting in a relatively long, gradual expansion of the mode-field diameter over a length of about 1 mm to about 6 mm, more preferably, of about 2 mm to about 4 mm. The gradual mode-field diameter expansion minimizes the splice loss after the heat-treated fiber is spliced. The organic liquid does not require additives and burns clean. The preferred organic liquids, (alcohols with six or fewer carbon atoms and only one hydroxyl group, more preferably, methanol) generate primarily water vapor and CO₂. Hence, the flame does not leave an organic residue on the fiber.

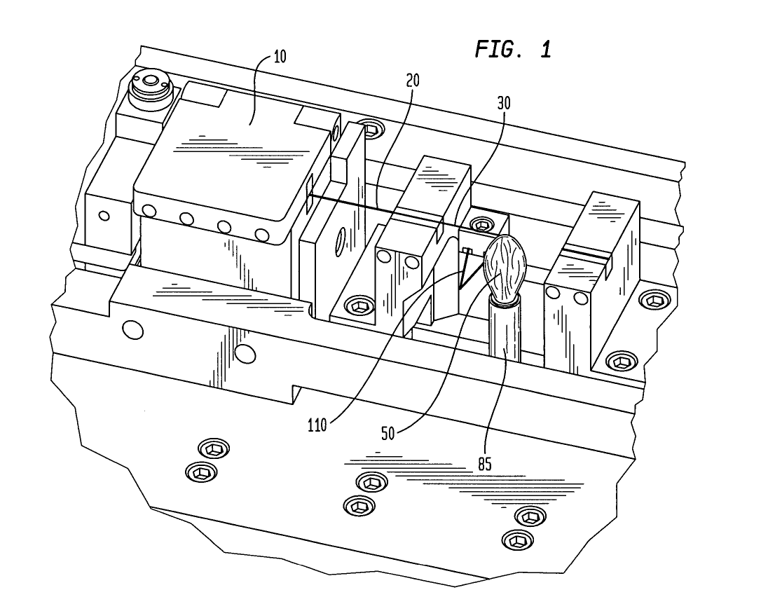

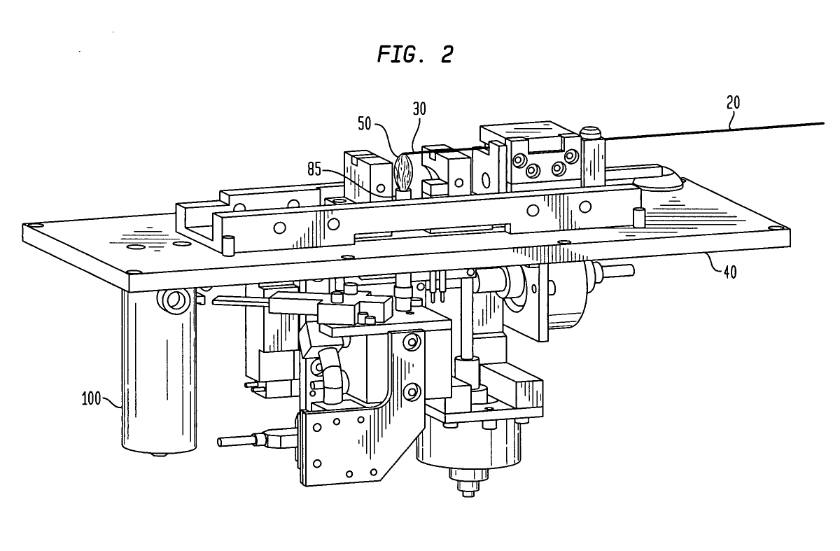

FIGS. 1-3 illustrate an apparatus convenient for expanding the mode field of an optical fiber according to the methods of the invention. The apparatus comprises holding block 10 for holding a fiber 20 having a stripped end 30. The block 10 is placed on a flame diffuser apparatus 40 (FIG. 2) for providing an organic-liquid-fueled flame 50 to the stripped end portion 30 of fiber 20.

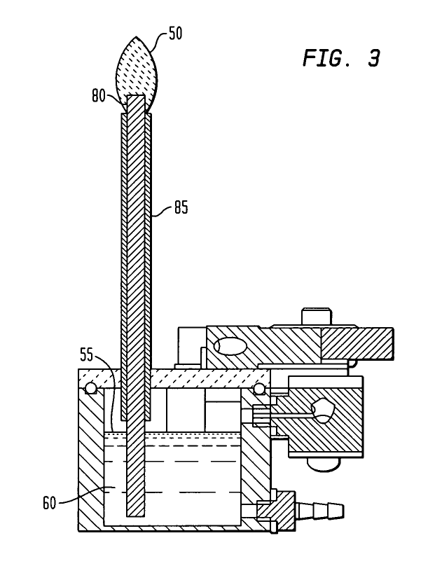

In a preferred embodiment, an organic liquid 55 is contained in reservoir 60 within apparatus 40, having wick 80 (FIG. 3) within protecting tube 85. The preferred wick material is fiberglass, preferably, a cylindrical length having a diameter of about 1/16 inch. The end of wick 80 is lit to provide flame 50. Preferably, apparatus 40 comprises a mechanism, such as pump 100, to maintain the level of organic liquid 55 in reservoir 60 at a constant level. Then, the end 30 of optical fiber 20 is positioned in an area of flame 50 providing the appropriate temperature profile, preferably from about 1100° C. to about 1200° C. The region of the flame with the appropriate temperature profile can be determined by well-known methods, such as with the use of thermocouple 110. An organic liquid typically burns in air giving a flame having an inner an outer envelope. When a methanol-fueled flame is used, the area having the appropriate temperature profile is directly above the end of the flame's inner tip, which is located between the inner and outer envelope of the flame.

To match the mode field of a smaller-mode-field-diameter optical fiber, such as a dispersion compensating fiber, to a larger-mode-field-diameter fiber, such as a standard transmission fiber, the end of the smaller mode field optical fiber is heated in the flame until its mode field matches that of the larger fiber. Typically, the heating period is about 1 minute to about 40 minutes, more preferably, about 10 to about 30 minutes. In general, the mode field of a dispersion compensating fiber (for splicing to a standard transmission fiber) is expanded from about 5 microns to about 10 to 12 microns. The mode-field diameter is measured by methods well known in the art, such as the far field pattern method.

Once the mode-field diameters are matched, the optical fibers are spliced using methods well known in the art, for example, the fusion splicing method described in U.S. Pat. No. 4,958,905 (issued Sep. 25, 1990) hereby incorporated herein by reference. Splice losses of under 0.5 dB are achieved, typically, from about 0.05 dB to about 0.3 dB, preferably, from about 0.05 dB to about 0.2 dB, more preferably, from about 0.05 to about 0.1 dB.

In brief, the ends of the two optical fibers are coaxially aligned and an electrically heated conductive filament provides sufficient heat to fuse the fibers together, and at the same time, a non-reactive inert gas is flowed over the fiber ends to remove volatile material.

The invention may now be more clearly understood by consideration of the following specific examples.

### 6. EXAMPLE

A dispersion compensating fiber having a dispersion of −100 ps/nm/km at 1550 nm and a mode field diameter of about 5 microns is cleaved. A methanol-fueled flame is provided by inserting a wick constructed of fiberglass having a diameter of about 1/16 inch into a methanol reservoir and lighting the wick. The cleaved end is positioned over the inner tip of the flame (about the center of the methanol flame) for 20 minutes wherein the mode field is adiabatically expanded to about 12 microns over a length of about 3 mm.

The mode-field expanded dispersion compensating fiber is then spliced to a standard single mode transmission fiber having a mode field diameter of 10.5 microns according to well-known methods, for example, by using a Vytran FFS-2000ä Splicing Work Station. The splice loss is under 0.20 dB measured at 1550 nm. With no mode-field expansion step the splice loss was about 0.7 to 0.8 dB.

In view of the Summary, Drawings, and Detailed Description presented above, it is clear that the invention comprises the following embodiments:

In one embodiment, the invention comprises a method for expanding the mode-field diameter of an optical fiber comprising heating an end of the optical fiber to a temperature of about 500° C. to about 2000° C. Preferably, the optical fiber is a dispersion compensating fiber.

In another embodiment, the invention is directed to a method of splicing a first optical fiber having a smaller mode-field diameter to a second optical fiber having a larger mode field diameter comprising:

(a) heating the end of the first optical fiber having the smaller mode field diameter to a temperature of about 500° C. to about 2000° C. to expand the mode field; and

(b) abutting the end of the expanded mode field fiber with the end of the second optical fiber having the larger mode field diameter. Preferably, the first optical fiber having the smaller mode field diameter is a dispersion compensating fiber.

In another embodiment, the invention relates to a method for expanding the mode-field diameter of an optical fiber comprising heating the optical fiber to a temperature of about 500° C. to about 2000° C. by applying heat to the optical fiber generated by a fuel source, wherein the fuel source comprises an organic liquid. Preferably, the optical fiber is a dispersion compensating fiber. In one aspect of this embodiment, the heat generated by the organic fuel source is applied to an internal section of the optical fiber. In a second step, the optical fiber is cleaved at the area of heat application to provide an optical fiber having an end with an expanded mode field diameter adapted to be spliced with a low splice loss.

Although the present invention has been described in considerable detail with reference to certain preferred embodiments and versions, other versions and embodiments are possible and within the scope of the invention. Therefore, the scope of the appended claims should not be limited to the description of the versions and embodiments expressly disclosed herein.

What is claimed is:

1. A method for expanding the mode-field diameter of an optical fiber comprising heating an end of the optical fiber to a temperature of about 500° C. to about 2000° C.

2. The method of claim 1, wherein the optical fiber is a dispersion compensating fiber.

3. The method of claim 1, wherein the fiber is heated for a period of about 1 to about 40 minutes.

4. The method of claim 1, wherein the fiber is heated for a period of about 10 to about 30 minutes.

5. The method of claim 1, wherein the fiber is adapted to be spliced to a second optical fiber having a larger mode field diameter with a splice loss of from about 0.05 dB to about 0.3 dB.

6. The method of claim 1, wherein the fiber has an adiabatic taper of from about 1 mm to about 6 mm.

7. The method of claim 1, wherein heating the end of the optical fiber comprises applying heat generated by a fuel source, wherein the fuel source comprises an organic liquid.

8. The method of claim 7, wherein the organic liquid comprises an alcohol.

9. The method of claim 7, wherein the organic liquid comprises an alcohol of six or fewer carbons and having only one hydroxyl group.

10. The method of claim 7, wherein the organic liquid comprises methanol.

11. A method of splicing a first optical fiber having a smaller mode-field diameter to a second optical fiber having a larger mode field diameter comprising:
(a) heating the end of the first optical fiber having the smaller mode field diameter to a temperature of about 500° C. to about 2000° C. to expand the mode field; and
(b) abutting the end of the expanded mode field fiber with the end of the second optical fiber having the larger mode field diameter.

12. The method of claim 11, wherein the first optical fiber having the smaller mode field diameter is a dispersion compensating fiber.

13. The method of claim 11, wherein the fiber is heated for a period of about 1 to about 40 minutes.

14. The method of claim 11, wherein the fiber is heated for a period of about 10 to about 30 minutes.

15. The method of claim 11, wherein the fiber is adapted to be spliced to a second optical fiber having a larger mode field diameter with a splice loss of from about 0.05 dB to about 0.3 dB.

16. The method of claim 11, wherein the fiber has an adiabatic taper of from about 1 mm to about 6 mm.

17. The method of claim 11,wherein heating the end of the optical fiber comprises applying heat generated by a fuel source, wherein the fuel source comprises an organic liquid.

18. The method of claim 17, wherein the organic liquid comprises an alcohol.

19. The method of claim 17, wherein the organic liquid comprises an alcohol of six or fewer carbons and having only one hydroxyl group.

20. The method of claim 17, wherein the organic liquid comprises methanol.

21. A method for expanding the mode-field diameter of an optical fiber comprising heating the optical fiber to a temperature of about 500° C. to about 2000° C. by applying heat to the optical fiber generated by a fuel source, wherein the fuel source comprises an organic liquid.

22. The method of claim 21, wherein the optical fiber is a dispersion compensating fiber.

23. The method of claim 21, wherein the fiber is heated for a period of about 1 to about 40 minutes.

24. The method of claim 21, wherein the fiber is heated for a period of about 10 to about 30 minutes.

25. The method of claim 21, wherein the organic liquid comprises an alcohol.

26. The method of claim 21, wherein the organic liquid comprises an alcohol of six or fewer carbons and having only one hydroxyl group.

27. The method of claim 21, wherein the organic liquid comprises methanol.
